(19) United States
(12) Patent Application Publication
(10) Pub. No.: US 2026/0318272 A1
(43) Pub. Date: Oct. 15, 2026

(54) shower control method and system based on multifunctional hydroelectric valve bodies

(71) Applicant: Guangzhou Homedec Sanitary Ware Co., Itd, Guangzhou (CN)

(72) Inventor: Wenying Guo, Guangzhou (CN)

(21) Appl. No.: 19/224,651

(22) Filed: May 30, 2025

(30) Foreign Application Priority Data
Apr. 11, 2025 (CN) 202510455740.2

(51) Int. Cl. B05B 15/00; F03B 13/00

(52) U.S. Cl. CPC B05B 15/00; F03B 13/00

(57) ABSTRACT

Disclosed are a shower control method and system based on multifunctional hydroelectric valve bodies. The method includes: acquiring a plurality of water supply paths corresponding to a plurality of hydroelectric valve bodies, and identifying the path features and pipe features of the plurality of water supply paths; grouping the plurality of water supply paths according to the path features and the pipe features, setting a plurality of flow control modes according to grouping results, and when triggering a first hydroelectric valve body to acquire a corresponding knob parameter, acquiring a first matched flow control mode corresponding to a water supply path of the first hydroelectric valve body; performing power analysis for flow control and supply based on the first matched flow control mode, outputting a first power control parameter, and performing power control of a hydroelectric power generation device according to the first power control parameter.

### TECHNICAL FIELD

The present disclosure relates to the field of intelligent control, and in particular to a shower control method and system based on multifunctional hydroelectric valve bodies.

### BACKGROUND

In modern home life, consumers have been paying an increasing attention to control intelligence and convenience of shower as an essential component of a shower system. Conventional shower control usually relies on mechanical switches or knobs, and users need to control water flow including magnitude and mode switching through manual regulation. Such control approach results in cumbersome and slow operation, lack of intuitiveness, and poor user experience.

With technological advancements and popularization of smart home concepts, people have begun to seek more intelligent and user-friendly shower control solutions. Some smart shower systems of the prior art have electronic touch or remote control functions, but these systems usually overlook multi-factor influences on water flow control, which results in low scenario adaptability, imprecise flow control, and inefficient power utilization. Furthermore, smart shower systems of the prior art usually are subjected to abrupt changes in control parameters during switching between multiple water outlet modes, which results in relatively poor user experience. Additionally, these systems lack intuitive visual feedback mechanisms, and users cannot intuitively understand current operating states of showers.

### SUMMARY

In order to overcome the technical defects of showers in the prior art including cumbersome control, lack of intuitiveness, imprecise flow control, low power utilization efficiency, and unsmooth mode switching, the present disclosure provides a shower control method and system based on multifunctional hydroelectric valve bodies.

A technical solution for overcoming the above technical defects is as follows: In a first aspect, a shower control method based on multifunctional hydroelectric valve bodies is provided by the present disclosure, and the method includes: acquiring a plurality of water supply paths corresponding to a plurality of hydroelectric valve bodies, where each hydroelectric valve body is independently controlled; identifying path features and pipe features of the plurality of water supply paths, where the path features include a supply height and a supply distance, and the pipe features include a pipe diameter and a bending radius; grouping the plurality of water supply paths according to the path features and the pipe features, setting a plurality of flow control modes according to grouping results, and when triggering a first hydroelectric valve body to acquire a corresponding knob parameter, acquiring a first matched flow control mode corresponding to a water supply path of the first hydroelectric valve body, where the first hydroelectric valve body is any one of the plurality of hydroelectric valve bodies; and performing power analysis for flow control and supply based on the first matched flow control mode, outputting a first power control parameter, and performing power control of a hydroelectric power generation device according to the first power control parameter.

In a second aspect, the present disclosure provides a shower control system based on multifunctional hydroelectric valve bodies, and the system includes: a water supply path acquisition module, configured to acquire a plurality of water supply paths corresponding to a plurality of hydroelectric valve bodies, where each hydroelectric valve body is independently controlled; a feature recognition module, configured to identify path features and pipe features of the plurality of water supply paths, where the path features include the supply height and the supply distance, and the pipe features include the pipe diameter and the bending radius; a path sorting module, configured to group the plurality of water supply paths according to the path features and the pipe features, set a plurality of flow control modes according to grouping results, and when triggering a first hydroelectric valve body to acquire a corresponding knob parameter, acquire a first matched flow control mode corresponding to a water supply path of the first hydroelectric valve body, where the first hydroelectric valve body is any one of the plurality of hydroelectric valve bodies; and a power control module, configured to perform power analysis for flow control and supply based on the first matched flow control mode, output the first power control parameter, and perform power control of the hydroelectric power generation device according to the first power control parameter.

The present disclosure has the beneficial effects as follows: by analyzing the water supply path features and pipe features, and performing power analysis based on the matched flow control mode, the present disclosure achieves independent and precise control of a plurality of hydroelectric valve bodies, efficiently controls the operation of hydroelectric power generation device, achieves accurate flow control and efficient power utilization, enables a smooth switching experience and intuitive visual feedback, and meets user needs for intelligent, convenient, and comfortable showering.

### BRIEF DESCRIPTION OF THE DRAWINGS

FIG. 1 is a schematic diagram of a work flow of a shower control method based on multifunctional hydroelectric valve bodies provided by the present disclosure.

FIG. 2 is a schematic structural diagram of a shower control system based on multifunctional hydroelectric valve bodies provided by the present disclosure.

Reference numerals in the figures: water supply path acquisition module 11, feature recognition module 12, path sorting module 13, and power control module 14.

### DETAILED DESCRIPTIONS OF THE EMBODIMENTS

The technical solutions in the examples of the present disclosure will be clearly and completely described below in combination with the accompanying drawings in the examples of the present disclosure. Apparently, the examples described are merely some rather than all of the examples of the present disclosure. All other examples acquired by those skilled in the art without making creative efforts based on the examples of the present disclosure fall within the scope of protection of the present disclosure.

In the description of the present disclosure, the terms “first” and “second” are only used for descriptive purposes, and should not be construed as indicating or implying relative importance or implicitly indicating the number of technical features indicated. Thus, a feature defined with “first” and “second” may explicitly or implicitly include one or more of the features. In the description of the present disclosure, “a plurality of” means two or more, unless expressly specified otherwise.

In the description of the present disclosure, the term “for example” denotes “used for illustration, exemplification, or explanation”. Any example described in the present disclosure as “for example” is not necessarily interpreted as being more preferred or advantageous than other examples. To enable any person skilled in the art to implement and use the present disclosure, the following description is provided. In the following description, details are listed for explanatory purposes. It is to be understood that those of ordinary skill in the art may recognize that the present disclosure may be implemented without use of these specific details. In other instances, well-known structures and processes are not elaborated in detail to avoid obscuring the description of the present disclosure due to unnecessary particulars. Therefore, the present disclosure is not intended to be limited to the shown examples, but is consistent with the broadest range of the principles and features disclosed in the present disclosure.

### Example 1

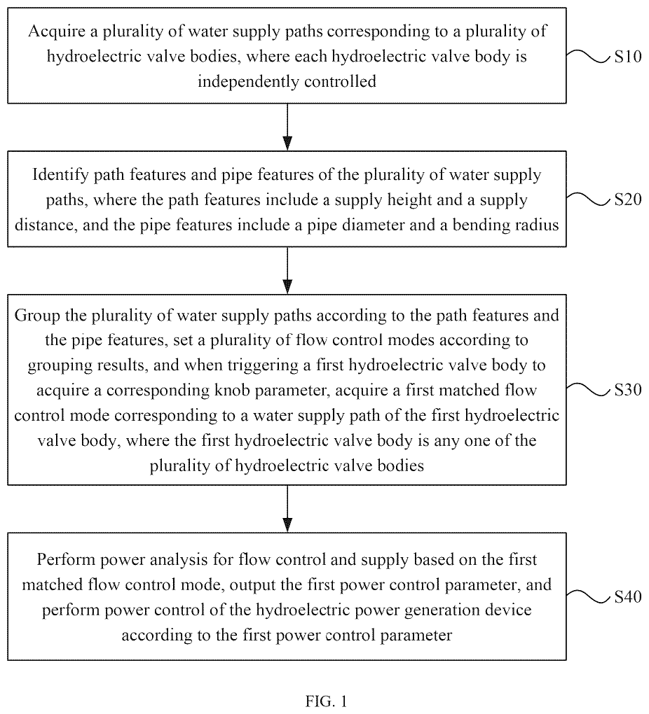

As illustrated in FIG. 1, a shower control method based on multifunctional hydroelectric valve bodies is provided in an example of the present disclosure, and the method includes:
S10: Acquire a plurality of water supply paths corresponding to a plurality of hydroelectric valve bodies, where each hydroelectric valve body is independently controlled.

For example, a core structure of a multifunctional hydroelectric valve body shower mainly includes a plurality of hydroelectric valve bodies, a water supply path system, a hydroelectric power generation device, a control system, and the like. Each of the plurality of hydroelectric valve bodies is an independently controlled unit responsible for regulating and distributing water flow. A flow regulation mechanism is arranged inside each of the valve bodies, which allows for fine-tuning according to user needs. Additionally, the valve body is externally provided with a knob and a LED lamp, where the knob is configured for manual operation by the user, and the LED lamp is configured for displaying an operating state of the valve body. The water supply path system is composed of a plurality of water supply paths, each water supply path is connected to one of the hydroelectric valve bodies, and geometric parameters of these paths, such as a supply height, a supply distance, a pipe diameter, and a bending radius, are meticulously designed to ensure smooth and efficient water flow. These parameters serve as critical references for the control system to achieve flow control and power analysis. The hydroelectric power generation device is connected to the water supply path system, which enables real-time actuation of the control system and other power-dependent components, such as lighting up the LED lamp arranged on a surface of the knob. Serving as a core of the multifunctional hydroelectric valve body shower, the control system is configured to receive user inputs, analyze features of water supply paths and pipes, set flow control modes, output power control parameters, and control operation of the hydroelectric power generation device. Based on advanced algorithms and sensor technologies, the control system achieves precise flow control and efficient energy utilization.

Specifically, the principle of the technical solution is as follows: a plurality of water supply paths corresponding to a plurality of hydroelectric valve bodies are acquired, where each hydroelectric valve body is independently controlled, indicating that the user is allowed to individually regulate water flow of each valve body. Then the control system identifies path features and pipe features of these water supply paths, the features include the supply height, the supply distance, the pipe diameter, the bending radius, and the like, and these parameters are crucial for determining water flow resistance and flow rates. The water supply paths are grouped based on the path features and pipe features, and a plurality of flow control modes are configured according to grouping results. Each group may correspond to different flow features and control requirements. When the user triggers a specific hydroelectric valve body (e.g., a first hydroelectric valve body) to acquire a corresponding knob parameter, the system acquires a first matched flow control mode corresponding to a water supply path of the hydroelectric valve body, and then performs power analysis for flow control and supply based on the matched flow control mode. This step involves calculating a required power output of the hydroelectric power generation device to ensure precise control over water flow. Finally, a first power control parameter is outputted and power control of the hydroelectric power generation device is performed based on the parameter, to achieve precise regulation of water flow. When the user subsequently triggers another hydroelectric valve body, the system repeats the above process, and may implement differentiated control strategies (such as smooth transition or collaborative control) according to many factors including a trigger interval and whether two valve bodies belong to the same group, to ensure continuity and stability in flow control.

Preferably, to acquire a plurality of water supply paths corresponding to a plurality of hydroelectric valve bodies, an internal structure and layout of the shower generally need to be analyzed and measured in detail. A position, a connection method, and relevant pipe sizes of each hydroelectric valve body, including pipe routing, a branching situation, and any factors that may affect water flow, such as the bending radius and the supply height, may be acquired by obtaining design blueprints and other means, to accurately obtain a plurality of water supply paths corresponding to a plurality of hydroelectric valve bodies. These data serve as critical references for subsequent flow control and power analysis.
S20: Identify path features and pipe features of the plurality of water supply paths, where the path features include the supply height and the supply distance, and the pipe features include the pipe diameter and the bending radius.

Further, path features and pipe features of a plurality of water supply paths are identified, where the path features include the supply height and the supply distance. The supply height refers to a height required for water flow to rise or fall from a source to each hydroelectric valve body, and influences potential energy and flow velocity of water flow. For example, when a specific valve body is located at a higher position, additional power may be needed to maintain sufficient water pressure, so as to better control the hydroelectric power generation device. The supply distance refers to a straight-line distance from the source to the valve body, and relates to a friction loss and flow efficiency of water flow. The pipe features include the pipe diameter and the bending radius. The pipe diameter determines a cross-sectional area of water flow, which further affects a flow rate and flow velocity. A larger diameter allows more water to pass through, and is suitable for scenarios in which high flow rates are required. The bending radius reflects a curvature of pipe, and a bent pipe increases water flow resistance and turbulence, and reduces flow efficiency. For example, for a compact design of the shower, the pipe may be frequently bent to adapt to space limitations, and in this case, the bending radius is required to ensure smooth water flow. By comprehensively considering these path features and pipe features, the control system is capable of more accurately setting a flow control mode and optimizing power output from the hydroelectric power generation device, thereby achieving more intelligent and efficient flow control.
S30: Group the plurality of water supply paths according to the path features and the pipe features, set a plurality of flow control modes according to grouping results, and when triggering a first hydroelectric valve body to acquire a corresponding knob parameter, acquire a first matched flow control mode corresponding to a water supply path of the first hydroelectric valve body, where the first hydroelectric valve body is any one of the plurality of hydroelectric valve bodies.

Optionally, a plurality of water supply paths are intelligently grouped based on path features and pipe features of water supply paths. The grouping refers to a process of categorizing different water flow paths into a high-pressure zone, a low-pressure zone, a tortuous zone, and the like, with an aim to reuse control parameters according to similar water flow features so as to improve efficiency and reduce energy consumption.

Specifically, the supply height, the supply distance, the pipe diameter, the bending radius, and other features of each water supply path are analyzed, and then paths with similar features are classified as a same group. For example, relatively straight paths with higher supply heights and larger pipe diameters may be classified as the high-pressure zone, because they require stronger water flow and more efficient power control to maintain stable water flow. Conversely, paths with lower supply heights, curved pipes, and smaller diameters are classified as the tortuous zone, which require more precise flow control to overcome additional resistance.

After grouping, corresponding flow control modes are configured for each group, and these modes are tailored to common features of intra-group paths, with an aim to achieve optimal water flow control and power efficiency. When the user triggers the first hydroelectric valve body (i.e., any of the plurality of hydroelectric valve bodies) through the knob, the system quickly identifies the group to which the valve body belongs and acquires a first matched flow control mode. This mode is then used to adjust an output of the hydroelectric power generation device, which ensures appropriate water flow for the first hydroelectric valve body, and precisely controls turbulent water flow in the high-pressure zone or laminar water flow in the tortuous zone.
S40: Perform power analysis for flow control and supply based on the first matched flow control mode, output the first power control parameter, and perform power control of the hydroelectric power generation device according to the first power control parameter.

Specifically, after determining the first matched flow control mode, power analysis for flow control and supply is performed based on the mode. In a specific analysis process, water flow demands, path features, and pipe features are comprehensively considered to accurately calculate power required to maintain the flow control mode. For example, if the first matched flow control mode is specific to turbulent water flow in the high-pressure zone, power analysis may require more power to drive the hydroelectric power generation device to produce sufficient water pressure and flow rate. The first power control parameters are outputted based on power analysis, and these parameters are critical for precisely regulating the output of the hydroelectric power generation device, maybe including a voltage, current, and a frequency, specifically depending on a type and features of the hydroelectric power generation device. For example, output of certain high-efficiency hydroelectric power generation device may be optimized by regulating the voltage and frequency to meet needs of water flow in the high-pressure zone. Finally, precise power control of the hydroelectric power generation device is achieved based on these first power control parameters. This indicates that the hydroelectric power generation device dynamically adjusts its output according to the user's actual needs and the features of water flow paths, to ensure stability and efficiency of water flow. For example, when the user needs turbulent water flow for rinsing, the hydroelectric power generation device quickly responds to support water flow in the high-pressure zone by providing sufficient power; and when the user needs laminar water flow for gentle cleaning, the hydroelectric power generation device reduces its output to adapt to water flow in the tortuous zone or the low-pressure zone. Adaptive regulation ensures energy saving of the hydroelectric power generation device, stability of water flow, and regulation efficiency, thereby enhancing user experience.

In a preferred example, the grouping the plurality of water supply paths according to the path features and the pipe features include: after splicing processing based on the path features and the pipe features, obtain a plurality of parameter vectors corresponding to the plurality of water supply paths; set a plurality of grouping labels, where a parameter vector threshold corresponding to each grouping label is different; and taking the plurality of parameter vectors as input vectors, group the plurality of water supply paths using a K-means algorithm to obtain a grouping result that achieves an optimization objective, where the optimization objective is to minimize an intra-group variance.

Preferably, the grouping the plurality of water supply paths according to the path features and the pipe features first involves splicing processing of the path features (such as the supply height and the supply distance) and the pipe features (such as the pipe diameter and the bending radius) to form a comprehensive parameter vector that fully reflects the features of each water supply path. For example, a parameter vector of a water supply path may include specific values such as a supply height of 50 m, a supply distance of 10 m, a pipe diameter of 0.6 m, and a bending radius of 2 m. Next, a plurality of grouping labels are set, a parameter vector threshold corresponding to each grouping label is different, and the thresholds are set based on actual requirements and experience to distinguish power supply paths of different features. For example, Group 1 may correspond to paths with large supply heights (H≥50 m) and a smaller ratio of the pipe diameter to the supply distance (R/D<2), which is suitable for a flow control mode featuring a low flow velocity and an increasing pressure; and Group 2 may correspond to paths with shorter supply distances (L≤10 m) and larger pipe diameters (D≥0.6 m), which is suitable for a flow control mode featuring a high flow velocity and a low pressure.

Subsequently, the system performs clustering analysis on the plurality of parameter vectors using the K-means algorithm, and assigns water supply paths to most suitable groups while minimizing the intra-group variance as the optimization objective. In this process, grouping of each path is continuously optimized through iterative computation until an optimal grouping result is achieved. For example, when a parameter vector of a water supply path is closer to a threshold of Group 1, the parameter vector is assigned to Group 1, and the flow control mode featuring a low flow velocity and an increasing pressure is selected accordingly. Such grouping approach helps to achieve more precise and efficient flow control, thereby enhancing user experience.

In a preferred example, when a second hydroelectric valve body is triggered to acquire a corresponding knob parameter, the following steps are included: the second hydroelectric valve body is any one of the plurality of hydroelectric valve bodies, and the second hydroelectric valve body is different from the first hydroelectric valve body; determine whether the second hydroelectric valve body and the first hydroelectric valve body belong to a same group, and when they belong to the same group, perform power control of the hydroelectric power generation device according to the first power control parameter; and when they do not belong to the same group, acquire a second matched flow control mode for the second hydroelectric valve body, perform power analysis for flow control and supply based on the second matched flow control mode, output the second power control parameter, and switch the first power control parameter to the second power control parameter to achieve power control over the hydroelectric power generation device.

Further, when operations of a plurality of hydroelectric valve bodies are involved, the system achieves switching between grouping management and power control. Taking the first hydroelectric valve body and the second hydroelectric valve body as an example, the second hydroelectric valve body is any one of the plurality of hydroelectric valve bodies, and is different from the first hydroelectric valve body. Specifically, it is first determined whether the two valve bodies belong to the same group. Grouping is based on the path features and the pipe features, with an aim to classify valve bodies with similar water flow features as the same group, so as to better reuse control parameters and enhance control efficiency. When the second hydroelectric valve body and the first hydroelectric valve body belong to the same group, the first power control parameter is used directly to achieve power control over the hydroelectric power generation device. It means that since the two valve bodies have similar water flow features, the same power control parameter may be used to drive the hydroelectric power generation device, thereby ensuring the stability and efficiency of water flow. However, when the second hydroelectric valve body and the first hydroelectric valve body do not belong to the same group, the second matched flow control mode for the second hydroelectric valve body is acquired. This mode is customized based on a feature parameter of the group to which the second hydroelectric valve body belongs, with an aim to achieve optimal water flow control and power efficiency. Subsequently, the system performs power analysis for flow control and supply based on the second matched flow control mode and outputs the second power control parameter. Finally, power control of the hydroelectric power generation device is achieved by switching from the first power control parameter to the second power control parameter. This switching process ensures that the hydroelectric power generation device provides an appropriate power output according to actual needs for the second hydroelectric valve body, which precisely controls turbulent water flow in the high-pressure zone or laminar water flow in the low-pressure zone.

For example, when the first hydroelectric valve body belongs to a group with a high supply height and a small pipe diameter (such as Group 1), and the second hydroelectric valve body belongs to a group with a short supply distance and a large pipe diameter (such as Group 2), and when the first hydroelectric valve body is switched to the second hydroelectric valve body, the power control parameter is adjusted accordingly to adapt to water flow features of the group to which the second hydroelectric valve body belongs. A flexible power control switching mechanism ensures that the multifunctional hydroelectric valve body shower provides the user with a more intelligent, efficient, and comfortable experience.

In a preferred example, when the second hydroelectric valve body is triggered to acquire the corresponding knob parameter, the following steps are further included: record time of triggering the first hydroelectric valve body and the second hydroelectric valve body, calculate an interval duration, and when the interval duration is greater than or equal to a first preset interval duration, switch the first power control parameter to the second power control parameter to achieve power control over the hydroelectric power generation device; when the interval duration is less than the first preset interval duration, adjust a difference control parameter through a short interval smooth transition algorithm to obtain a smooth difference control parameter, and achieve power control over the hydroelectric power generation device according to the smooth difference control parameter, where the difference control parameter represents a difference between the first power control parameter and the second power control parameter.

In a specific example, when the user triggers the second hydroelectric valve body to acquire the corresponding knob parameter, it is also required to ensure the stability and efficiency of power control. First, the system records specific time when the first hydroelectric valve body and the second hydroelectric valve body are triggered and calculates an interval duration between two trigger events. This step is used to determine whether the power control parameter needs to be immediately switched. When the interval duration is greater than or equal to the first preset interval duration, power control of the hydroelectric power generation device is achieved by directly switching from the first power control parameter to the second power control parameter. The first preset interval duration is configured usually according to system features and user needs, to avoid system oscillation caused by frequent switching of power parameters in a short time. Such switching ensures that the hydroelectric power generation device quickly adapts to water flow demands for the second hydroelectric valve body, thereby ensuring stability and efficiency of water flow.

However, when the interval duration is less than the first preset interval duration, immediate switching is not required, and a smoother transition strategy is adopted. Specifically, the difference control parameter is adjusted through the short interval smooth transition algorithm. The difference control parameter mentioned herein refers to a difference required to adjust from the first power control parameter to the second power control parameter. The system calculates the smooth difference control parameter according to the difference, current power control state and water flow demand. Subsequently, power control of the hydroelectric power generation device is achieved based on the smooth difference control parameter. Smooth transition prevents potential system oscillation caused by frequent switching of power parameters in a short time, and ensures stability and continuity of water flow. For example, when the user consecutively triggers two different hydroelectric valve bodies from different groups in a short time, the system does not immediately significantly switch the power parameter, but gradually adjusts the power output through the smooth transition algorithm to adapt to changing user demands. In summary, an intelligent control strategy not only enhances the stability and efficiency of the system, but also provides the user with a more comfortable and convenient experience.

In a preferred example, when the interval duration is less than the first preset interval duration, the system determines whether the interval duration is less than or equal to a second preset interval duration, where the second preset interval duration is less than the first preset interval duration; and when the interval duration is less than or equal to the second preset interval duration, collaborative analysis on the first power control parameter and the second power control parameter is performed to obtain a collaborative power control parameter, and power control of the hydroelectric power generation device is performed based on the collaborative power control parameter.

Optionally, when the user triggers the second hydroelectric valve body to acquire the corresponding knob parameter, and a trigger interval duration is less than the first preset interval duration, the system further determines whether the interval duration is less than or equal to the second preset interval duration. The second preset interval duration is arranged to be less than the first preset interval duration, which is used to identify situations where the user may nearly trigger both the first hydroelectric valve body and the second hydroelectric valve body simultaneously.

When the interval duration is indeed less than or equal to the second preset interval duration, it is believed that the user hopes to control two hydroelectric valve bodies simultaneously or nearly simultaneously, thereby necessitating the collaborative analysis of the first power control parameter and the second power control parameter. For the collaborative analysis, water flow demands, path features, and pipe features of two valve bodies are comprehensively considered to obtain a collaborative power control parameter that satisfies requirements for both the first hydroelectric valve body and the second hydroelectric valve body.

For example, when the first hydroelectric valve body requires higher water pressure to support turbulent water flow, the second hydroelectric valve body requires lower water pressure to provide laminar water flow. During the collaborative analysis, the system may determine an intermediate value or adjust the power control parameter according to relative importance of the two valve bodies (e.g., the user's preference for which valve body in the water flow effect) to ensure that the two valve bodies receive appropriate water flow support. Finally, power control of the hydroelectric power generation device is achieved based on the collaborative power control parameter. Therefore, even if the user triggers two different hydroelectric valve bodies with divergent operational requirements consecutively or near-simultaneously in a short time, the collaborative analysis enables to provide a stable and efficient power control solution to meet diverse user needs. The intelligent control strategy not only enhances the user experience, but also further improves practicality and flexibility of the multifunctional hydroelectric valve body shower.

In a preferred example, a difference control parameter is adjusted through a short interval smooth transition algorithm to obtain a smooth difference control parameter, with an expression as follows:

$$P ( t ) = {P}_{1} + ( {P}_{2} - {P}_{1} ) \frac{t}{{t}_{transition}} ;$$

where P(t) represents a real-time power control parameter of a hydroelectric valve body that changes over a time interval t after triggering, P₁ represents a first power control parameter obtained at the time of triggering a first hydroelectric valve body, P₂ represents a second power control parameter that needs to be switched after triggering a second hydroelectric valve body, and tₜᵣₐₙₛᵢₜᵢₒₙ represents a transition time constant, which refers to a total duration for switching from the first power control parameter to the second power control parameter.

Specifically, when the second hydroelectric valve body is triggered and the trigger interval duration is less than the first preset interval duration, the difference control parameter is adjusted through the short interval smooth transition algorithm to obtain the smooth difference control parameter. This algorithm mainly ensures smooth and continuous transition of the power control parameter from the first power control parameter to the second power control parameter, and prevents system oscillation caused by frequent switching in a short time. Specifically, this algorithm achieves a smooth transition through the following expression:

$$P ( t ) = {P}_{1} + ( {P}_{2} - {P}_{1} ) \frac{t}{{t}_{transition}} ;$$

where P(t) represents the real-time power control parameter of a hydroelectric valve body that changes over a time interval t after triggering, which reflects the system's demand for power control at different time points. P₁ represents the first power control parameter obtained at the time of triggering a first hydroelectric valve body, which serves as a starting point of transition; and P₂ represents the second power control parameter that needs to be switched after triggering a second hydroelectric valve body, which serves as an endpoint of transition. The transition time constant tₜᵣₐₙₛᵢₜᵢₒₙ is a critical parameter that indicates the total duration for switching from the first power control parameter to the second power control parameter. The system controls smoothness and speed of transition by adjusting the transition time constant. For example, when the transition time constant is set to be larger, the transition is smoother but may require an extended duration for completion; and conversely, when the transition time constant is set to be smaller, the transition is faster but maybe is insufficiently smooth.

In an exemplary practical scenario, when using the multifunctional hydroelectric valve body shower, the user first triggers the first hydroelectric valve body that requires high-pressure water flow, and then quickly triggers the second hydroelectric valve body that requires low-pressure water flow. Since the trigger interval duration is less than the first preset interval duration, the system does not immediately switch from high pressure to low pressure, but the short interval smooth transition algorithm is adopted. The system calculates a current smooth difference control parameter according to the current time interval t, the first power control parameter, the second power control parameter, and the transition time constant, and achieves power control of the hydroelectric power generation device accordingly. In this way, the user feels a smooth transition of water flow from high pressure to low pressure, and discomfort caused by abrupt changes of the hydroelectric power generation device in the power parameter is avoided.

In a preferred example, collaborative analysis on the first power control parameter and the second power control parameter is performed to obtain a collaborative power control parameter, with an expression as follows: P_{sync}=P₁e^{-kt}+P₂(1−e^{-kt}) where P_{sync} is a collaborative power control parameter, P₁ represents the first power control parameter obtained at the time of triggering the first hydroelectric valve body, t is a time interval, P₂ represents the second power control parameter that needs to be switched after triggering the second hydroelectric valve body, e is an attenuation constant for ensuring smooth transition, and k is an attenuation coefficient for controlling a transition rate.

In detail, in case of need to control two hydroelectric valve bodies simultaneously or nearly simultaneously, collaborative analysis of the first power control parameter and the second power control parameter is performed to obtain a collaborative power control parameter that satisfies requirements for both the first hydroelectric valve body and the second hydroelectric valve body. The collaborative analysis process is achieved through a specific mathematical expression to ensure a smooth and efficient transition of the power control parameter. Specifically, a calculation expression for the collaborative power control parameter is: P_{sync}=P₁e^{-kt}+P₂(1−e^{-kt}), where P_{sync} is the collaborative power control parameter; P₁ represents the first power control parameter obtained at the time of triggering the first hydroelectric valve body, which serves as a starting point of collaborative analysis; and P₂ represents the second power control parameter that needs to be switched after triggering the second hydroelectric valve body, which serves as an endpoint of collaborative analysis. The time interval t reflects a difference between two hydroelectric valve bodies in triggering time and has a significant impact on calculation of the collaborative power control parameter. The attenuation constant e and the attenuation coefficient k are key parameters for ensuring smooth transition. The attenuation constant determines an attenuation velocity of the power control parameter over time, and the attenuation coefficient controls a rate of attenuation. By adjusting the two parameter, the system flexibly controls transition features of the collaborative power control parameter to adapt to various use scenarios and demands.

In an exemplary practical scenario, when using the multifunctional hydroelectric valve body shower, the user simultaneously triggers two hydroelectric valve bodies that require different water flow intensities. The system calculates a current collaborative power control parameter according to the current time interval t, the first power control parameter, the second power control parameter, and the preset attenuation constant and attenuation coefficient through collaborative analysis. Then, the system achieves power control of the hydroelectric power generation device according to the collaborative power control parameter, ensures that the two valve bodies receive appropriate water flow support, and avoids discomfort caused by abrupt changes in the power parameter.

In a preferably example, each of the plurality of hydroelectric valve bodies is provided with a corresponding LED lamp; and after triggering of the first hydroelectric valve body to acquire the corresponding knob parameter, visual feedback on a triggering state is achieved through the LED lamp, where the visual feedback on a triggering state includes color feedback and brightness feedback.

Specifically, each hydroelectric valve body is provided with a corresponding LED lamp, which not only enhances sense of science and technology of the hydroelectric power generation device, but also optimizes the user experience. When the user triggers the first hydroelectric valve body to acquire the corresponding knob parameter, the system immediately provides visual feedback through the LED lamp to intuitively display a triggering state. The visual feedback mainly includes the color feedback and the brightness feedback.

Regarding color feedback, the system may preset different colors to represent different triggering states or water flow modes. For example, when the first hydroelectric valve body is triggered in a high-pressure water flow mode, the LED lamp may illuminate in blue to clearly show a current water flow state to the user. In a low-pressure water flow mode, light may change to green to provide immediate visual prompts.

Brightness feedback, through brightness changes of light, reflect an operating state of the hydroelectric valve body or an adjustment of power control parameter. For example, during smooth transition of power control parameter, the LED lamp may gradually change from dim to bright or from bright to dim, to simulate changes in the water flow intensity, which enables the user to intuitively feel the transition of water flow from weak to strong or from strong to weak.

In an exemplary practical scenario, to adjust the water flow intensity of the shower when bathing, the user may rotate the knob of the first hydroelectric valve body, and the system immediately responds and triggers a corresponding water flow mode. Simultaneously, the LED lamp lights up, and presents a specific color and brightness to intuitively show the current water flow state to the user. The visual feedback not only enhances the convenience of use, but also enables the user to experience the sense of intelligence and fun from technology when enjoying a comfortable water flow.

The shower control method based on multifunctional hydroelectric valve bodies provided in an example of the present disclosure at least has the following technical effects:
1. By identifying the path features and pipe features of a plurality of water supply paths, the system intelligently groups the water supply paths through the K-means algorithm, and sets a corresponding flow control mode for each group. The grouping approach ensures that the system achieves precise flow control and power distribution according to actual needs for different hydroelectric valve bodies, thereby enhancing water resource utilization efficiency and user comfort.
2. When different hydroelectric valve bodies are triggered, the system determines whether they belong to the same group and switches the power control parameter as needed. In particular, when the trigger interval duration is relatively short, the system employs the short interval smooth transition algorithm or collaborative analysis to acquire the smooth difference control parameter or the collaborative power control parameter, which ensures smooth and continuous switching of power parameter, and avoids system oscillation and discomfort experience caused by abrupt changes in the power parameter. The technical effects of smooth transition and collaborative control significantly enhance system stability and response speed.
3. Each hydroelectric valve body is provided with a corresponding LED lamp, which is used for visual feedback on the triggering state. The color feedback and the brightness feedback enable the user to intuitively understand the current operating state and flow control mode of the hydroelectric valve body, which facilitates operation. A visual feedback mechanism not only enhances the convenience of use, but also enhances the user's perception and understanding of system state, which makes the entire shower control system more intelligent and user-friendly.

### Example 2

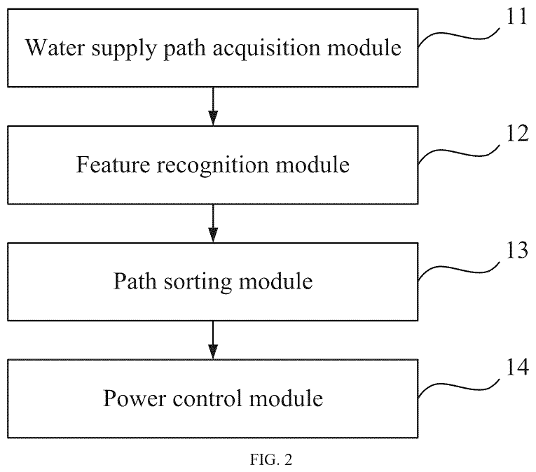

As illustrated in FIG. 2, based on the same inventive concept of the shower control method based on multifunctional hydroelectric valve bodies provided in Example 1, a shower control system based on multifunctional hydroelectric valve bodies is further provided in an example of the present disclosure, and the system includes:

A water supply path acquisition module 11, configured to acquire a plurality of water supply paths corresponding to a plurality of hydroelectric valve bodies, where each hydroelectric valve body is independently controlled.

A feature recognition module 12, configured to identify path features and pipe features of the plurality of water supply paths, where the path features include the supply height and the supply distance, and the pipe features include the pipe diameter and the bending radius.

A path sorting module 13, configured to group the plurality of water supply paths according to the path features and the pipe features, set a plurality of flow control modes according to grouping results, and when triggering a first hydroelectric valve body to acquire a corresponding knob parameter, acquire a first matched flow control mode corresponding to a water supply path of the first hydroelectric valve body, where the first hydroelectric valve body is any one of the plurality of hydroelectric valve bodies.

A power control module 14, configured to perform power analysis for flow control and supply based on the first matched flow control mode, output the first power control parameter, and perform power control of the hydroelectric power generation device according to the first power control parameter.

Furthermore, the path sorting module 13 is further used to execute the following steps:
after splicing processing based on the path features and the pipe features, obtain a plurality of parameter vectors corresponding to the plurality of water supply paths; set a plurality of grouping labels, where a parameter vector threshold corresponding to each grouping label is different; and taking the plurality of parameter vectors as input vectors, group the plurality of water supply paths using a K-means algorithm to obtain a grouping result that achieves an optimization objective, where the optimization objective is to minimize an intra-group variance.

Furthermore, the path sorting module 13 is further used to execute the following steps:
the second hydroelectric valve body is any one of the plurality of hydroelectric valve bodies, and the second hydroelectric valve body is different from the first hydroelectric valve body; determine whether the second hydroelectric valve body and the first hydroelectric valve body belong to a same group, and when they belong to the same group, perform power control of the hydroelectric power generation device according to the first power control parameter; and when they do not belong to the same group, acquire a second matched flow control mode for the second hydroelectric valve body, perform power analysis for flow control and supply based on the second matched flow control mode, output the second power control parameter, and switch the first power control parameter to the second power control parameter to achieve power control over the hydroelectric power generation device.

Furthermore, the path sorting module 13 is further used to execute the following steps:

record time of triggering the first hydroelectric valve body and the second hydroelectric valve body, calculate an interval duration, and when the interval duration is greater than or equal to a first preset interval duration, switch the first power control parameter to the second power control parameter to achieve power control over the hydroelectric power generation device; when the interval duration is less than the first preset interval duration, adjust a difference control parameter through a short interval smooth transition algorithm to obtain a smooth difference control parameter, and achieve power control over the hydroelectric power generation device according to the smooth difference control parameter, where the difference control parameter represents a difference between the first power control parameter and the second power control parameter.

Furthermore, the path sorting module 13 is further used to execute the following steps:
when the interval duration is less than the first preset interval duration, the system determines whether the interval duration is less than or equal to a second preset interval duration, where the second preset interval duration is less than the first preset interval duration; and when the interval duration is less than or equal to the second preset interval duration, collaborative analysis on the first power control parameter and the second power control parameter is performed to obtain a collaborative power control parameter, and power control of the hydroelectric power generation device is performed based on the collaborative power control parameter.

Furthermore, the path sorting module 13 is further used to execute the following steps:
a difference control parameter is adjusted through a short interval smooth transition algorithm to obtain a smooth difference control parameter, with an expression as follows:

$$P ( t ) = {P}_{1} + ( {P}_{2} - {P}_{1} ) \frac{t}{{t}_{transition}} ;$$

where P(t) represents a real-time power control parameter of a hydroelectric valve body that changes over a time interval t after triggering, P₁ represents a first power control parameter obtained at the time of triggering a first hydroelectric valve body, P₂ represents a second power control parameter that needs to be switched after triggering a second hydroelectric valve body, and tₜᵣₐₙₛᵢₜᵢₒₙ represents a transition time constant, which refers to a total duration for switching from the first power control parameter to the second power control parameter.

Furthermore, the path sorting module 13 is further used to execute the following steps:
collaborative analysis on the first power control parameter and the second power control parameter is performed to obtain a collaborative power control parameter, with an expression as follows: P_{sync}=P₁e^{-kt}+P₂(1−e^{-kt}) where P_{sync} is a collaborative power control parameter, P₁ represents the first power control parameter obtained at the time of triggering the first hydroelectric valve body, t is a time interval, P₂ represents the second power control parameter that needs to be switched after triggering the second hydroelectric valve body, e is an attenuation constant for ensuring smooth transition, and k is an attenuation coefficient for controlling a transition rate.

Furthermore, the path sorting module 13 is further used to execute the following steps:
each of the plurality of hydroelectric valve bodies is provided with a corresponding LED lamp; and after triggering of the first hydroelectric valve body to acquire the corresponding knob parameter, visual feedback on a triggering state is achieved through the LED lamp, where the visual feedback on a triggering state includes color feedback and brightness feedback.

Through a detailed description of the shower control method based on multifunctional hydroelectric valve bodies in the specification, those skilled in the art may clearly understand the shower control system based on multifunctional hydroelectric valve bodies in this example. Since the system disclosed in the examples corresponds to the method disclosed in the examples, the description is simple, and reference can be made to the method description.

The above description of the disclosed embodiments enables any person skilled in the art to implement or use the present disclosure. Various modifications to these examples will be readily apparent to those skilled in the art, and the generic principles defined herein may be implemented in other examples without departing from the spirit or scope of the present disclosure. Thus, the present disclosure is not intended to be limited to the embodiments shown herein, but is to be accorded with the widest scope consistent with the principles and novel features disclosed herein.

What is claimed is:

1. A shower control method based on multifunctional hydroelectric valve bodies, comprising the following steps:
acquiring a plurality of water supply paths corresponding to a plurality of hydroelectric valve bodies, wherein each hydroelectric valve body is independently controlled;
identifying path features and pipe features of the plurality of water supply paths, wherein the path features comprise a supply height and a supply distance, and the pipe features comprise a pipe diameter and a bending radius;
grouping the plurality of water supply paths according to the path features and the pipe features, setting a plurality of flow control modes according to grouping results, and when triggering a first hydroelectric valve body to acquire a corresponding knob parameter, acquiring a first matched flow control mode corresponding to a water supply path of the first hydroelectric valve body, wherein the first hydroelectric valve body is any one of the plurality of hydroelectric valve bodies; and
performing power analysis for flow control and supply based on the first matched flow control mode, outputting a first power control parameter, and performing power control of a hydroelectric power generation device according to the first power control parameter.

2. The shower control method based on multifunctional hydroelectric valve bodies according to claim 1, wherein the grouping the plurality of water supply paths according to the path features and the pipe features comprises:
after splicing processing based on the path features and the pipe features, obtaining a plurality of parameter vectors corresponding to the plurality of water supply paths;
setting a plurality of grouping labels, wherein a parameter vector threshold corresponding to each grouping label is different; and
taking the plurality of parameter vectors as input vectors, grouping the plurality of water supply paths using a K-means algorithm to obtain a grouping result that achieves an optimization objective, wherein the optimization objective is to minimize an intra-group variance.

3. The shower control method based on multifunctional hydroelectric valve bodies according to claim 1, wherein when a second hydroelectric valve body is triggered to acquire a corresponding knob parameter, the following steps are comprised:
the second hydroelectric valve body is any one of the plurality of hydroelectric valve bodies, and the second hydroelectric valve body is different from the first hydroelectric valve body;
when the second hydroelectric valve body and the first hydroelectric valve body belong to the same group, performing power control of a hydroelectric power generation device according to the first power control parameter; and
when they do not belong to the same group, acquiring a second matched flow control mode for the second hydroelectric valve body, performing power analysis for flow control and supply based on the second matched flow control mode, outputting a second power control parameter, and switching the first power control parameter to the second power control parameter to achieve power control over the hydroelectric power generation device.

4. The shower control method based on multifunctional hydroelectric valve bodies according to claim 3, wherein when the second hydroelectric valve body is triggered to acquire the corresponding knob parameter, the following steps are further comprised:
recording time of triggering the first hydroelectric valve body and the second hydroelectric valve body, calculating an interval duration, and when the interval duration is greater than or equal to a first preset interval duration, switching the first power control parameter to the second power control parameter to achieve power control over the hydroelectric power generation device;
when the interval duration is less than the first preset interval duration, adjusting a difference control parameter through a short interval smooth transition algorithm to obtain a smooth difference control parameter, and achieving power control over the hydroelectric power generation device according to the smooth difference control parameter; and
the difference control parameter refers to a difference required to adjust from the first power control parameter to the second power control parameter.

5. The shower control method based on multifunctional hydroelectric valve bodies according to claim 4, wherein when the interval duration is less than the first preset interval duration, the system determines whether the interval duration is less than or equal to a second preset interval duration, wherein the second preset interval duration is less than the first preset interval duration; and
when the interval duration is less than or equal to the second preset interval duration, collaborative analysis on the first power control parameter and the second power control parameter is performed to obtain a collaborative power control parameter, and power control of the hydroelectric power generation device is performed based on the collaborative power control parameter.

6. The shower control method based on multifunctional hydroelectric valve bodies according to claim 4, wherein the difference control parameter is adjusted through the short interval smooth transition algorithm to obtain the smooth difference control parameter, with an expression as follows:
$$P ( t ) = {P}_{1} + ( {P}_{2} - {P}_{1} ) \frac{t}{{t}_{transition}} ;$$
in the expression, P(t) represents a real-time power control parameter of a hydroelectric valve body that changes over a time interval t after triggering, P₁ represents a first power control parameter obtained at the time of triggering a first hydroelectric valve body, P₂ represents a second power control parameter that needs to be switched after triggering a second hydroelectric valve body, and tₜᵣₐₙₛᵢₜᵢₒₙ represents a transition time constant, which refers to a total duration for switching from the first power control parameter to the second power control parameter.

7. The shower control method based on multifunctional hydroelectric valve bodies according to claim 5, wherein collaborative analysis on the first power control parameter and the second power control parameter is performed to obtain a collaborative power control parameter, with an expression as follows:
P_{sync}=P₁e^{-kt}+P₂(1−e^{-kt});
in the expression, P_{sync} is a collaborative power control parameter, P₁ represents the first power control parameter obtained at the time of triggering the first hydroelectric valve body, t is a time interval, P₂ represents the second power control parameter that needs to be switched after triggering the second hydroelectric valve body, e is an attenuation constant for ensuring smooth transition, and k is an attenuation coefficient for controlling a transition rate.

8. The shower control method based on multifunctional hydroelectric valve bodies according to claim 1, wherein each of the plurality of hydroelectric valve bodies is provided with a corresponding LED lamp; and
after triggering of the first hydroelectric valve body to obtain the corresponding knob parameter, visual feedback on a triggering state is achieved through the LED lamp, wherein the visual feedback on a triggering state comprises color feedback and brightness feedback.

9. A shower control system based on multifunctional hydroelectric valve bodies, being applied to implement the shower control method based on multifunctional water valve bodies according to claim 1, comprising:
a water supply path acquisition module, being configured to acquire a plurality of water supply paths corresponding to a plurality of hydroelectric valve bodies, wherein each hydroelectric valve body is independently controlled;
a feature recognition module, being configured to identify path features and pipe features of the plurality of water supply paths, wherein the path features comprise the supply height and the supply distance, and the pipe features comprise the pipe diameter and the bending radius;
a path sorting module, being configured to group the plurality of water supply paths according to the path features and the pipe features, set a plurality of flow control modes according to grouping results, and when triggering a first hydroelectric valve body to acquire a corresponding knob parameter, acquire a first matched flow control mode corresponding to a water supply path of the first hydroelectric valve body, wherein the first hydroelectric valve body is any one of the plurality of hydroelectric valve bodies; and
a power control module, being configured to perform power analysis for flow control and supply based on the first matched flow control mode, output the first power control parameter, and perform power control of the hydroelectric power generation device according to the first power control parameter.
